(19) United States
(12) Patent Application Publication
(10) Pub. No.: US 2025/0338178 A1
(43) Pub. Date: Oct. 30, 2025

(54) SECONDARY CELL SELECTION FOR CARRIER AGGREGATION IN WIRELESS COMMUNICATION NETWORKS

(71) Applicant: T-MOBILE INNOVATIONS LLC, Overland Park, KS (US)

(72) Inventors: Sharath Somashekar, Overland Park, KS (US); Tu Nhu Nguyen, Annandale, VA (US); Khaled Omaira, Glen Ellyn, IL (US); David Lee-Chin, Overland Park, KS (US)

(21) Appl. No.: 18/647,093

(22) Filed: Apr. 26, 2024

(51) Int. Cl. H04W 36/00; H04B 17/318; H04L 5/14; H04W 24/02; H04W 36/30

(52) U.S. Cl. CPC H04W 36/0058; H04B 17/328; H04L 5/14; H04W 24/02; H04W 36/304

(57) ABSTRACT

Various embodiments relate to a system comprising access network circuitry. The access network circuitry wirelessly directs, over the primary cell, a user device to measure signal quality for secondary cells available for use in carrier aggregation. The access network circuitry compares the signal quality for each of the secondary cells to a signal quality threshold. The access network circuitry determines candidate secondary cells based on the secondary cells that exceeded the signal quality threshold. The access network circuitry ranks the candidate secondary cells based on their corresponding signal quality and one or more of the loading, resource block percent utilizations, and traffic pattern suitability for the candidate secondary cells. The access network circuitry wirelessly directs, over the primary cell, the wireless user device to utilize a highest ranked candidate secondary cell for use in the carrier aggregation.

### TECHNICAL FIELD

Various embodiments of the present technology relate to wireless communication, and more specifically, to optimizing secondary cell selection for use in carrier aggregation.

### BACKGROUND

Wireless communication networks provide wireless data services to wireless user devices. Exemplary wireless data services include internet-access, media-streaming, online gaming, social-networking, multimedia voice/video service, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Carrier aggregation is a type of wireless communication to increase the amount of data exchanged between wireless user devices and RANs. Carrier aggregation utilizes a primary cell and one or more secondary cells. The primary and secondary cells correspond to different radio frequency bands. Radio frequency bands are divided into multiple frequency blocks referred to as component carriers. The component carriers are used to carry the data and signaling between the RAN and user device. In carrier aggregation, multiple component carriers from the primary and secondary cell(s) are grouped to carry data and signaling between the RAN and user device. The grouped component carriers may be from the same radio band or different radio bands. When from the same band, the component carriers may be contiguous (e.g., adjacent resource blocks) or non-contiguous (e.g., non-adjacent resource blocks).

Selecting the appropriate secondary cell to use for carrier aggregation is difficult. In conventional wireless communication networks, the secondary cells are selected based on the bandwidth and the Physical Resource Block (PRB) percent utilization of the cell. However, a number of other criteria influence a secondary cell's suitability for use in a carrier aggregation. As such, conventional carrier selection methods often lead to non-optimal carrier aggregation cell combinations which degrades the user experience. The difficulty in selecting secondary cells is compounded as user devices do not trigger secondary cell reselection when radio conditions on the secondary cell degrade.

Unfortunately, wireless communication networks do not efficiently select secondary cells for carrier aggregation. Moreover, wireless communication networks do not effectively trigger secondary cell reselection.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for wireless communications. Some embodiments comprise a method. The method comprises wirelessly directing, over the primary cell, a user device to measure signal qualities for secondary cells available for use in carrier aggregation. The method further comprises comparing the signal qualities for the secondary cells to a signal quality threshold. The method further comprises determining candidate secondary cells based on the secondary cells that exceeded the signal quality threshold. The method further comprises ranking the candidate secondary cells based on their corresponding signal qualities and one or more of the loading, resource block percent utilizations, and traffic pattern suitability for the candidate secondary cells. The method further comprises wirelessly directing, over the primary cell, the wireless user device to utilize a highest ranked candidate secondary cell for use in the carrier aggregation.

Some embodiments comprise a system. The system comprises access network circuitry. The access network circuitry wirelessly directs, over the primary cell, a user device to measure signal quality for secondary cells available for use in carrier aggregation. The access network circuitry compares the signal quality for each of the secondary cells to a signal quality threshold. The access network circuitry determines candidate secondary cells based on the secondary cells that exceeded the signal quality threshold. The access network circuitry ranks the candidate secondary cells based on their corresponding signal quality and one or more of the loading, resource block percent utilizations, and traffic pattern suitability for the candidate secondary cells. The access network circuitry wirelessly directs, over the primary cell, the wireless user device to utilize a highest ranked candidate secondary cell for use in the carrier aggregation.

Some embodiments comprise one of more non-transitory computer readable storage media having program instructions stored thereon. When executed by a computing system, the program instructions direct the computing system to perform operations. The operations comprise wirelessly directing, over the primary cell, a user device to measure signal quality for secondary cells available for use in carrier aggregation. The operations further comprise comparing the signal quality for the secondary cells to a signal quality threshold. The operations further comprise determining candidate secondary cells based on the secondary cells that exceeded the signal quality threshold. The operations further comprise ranking the candidate secondary cells based on their corresponding signal quality and one or more of the loading, resource block percent utilizations, and traffic pattern suitability for the candidate secondary cells. The operations further comprise wirelessly directing, over the primary cell, the wireless user device to utilize a highest ranked candidate secondary cell for use in the carrier aggregation.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a communication network.

FIG. 2 illustrates an exemplary operation of the communication network.

FIG. 3 illustrates a wireless communication network.

FIG. 4 illustrates an exemplary operation of the wireless communication network.

FIG. 5 illustrates a Radio Access Network (RAN) in the wireless communication network.

FIG. 6 illustrates a Fifth Generation (5G) communication network.

FIG. 7 illustrates a 5G User Equipment (UE) in the 5G communication network.

FIG. 8 illustrates a 5G RAN in the 5G communication network.

FIG. 9 illustrates a machine learning model in the 5G RAN.

FIG. 10 further illustrates the machine learning model in the 5G RAN.

FIG. 11 illustrates a Network Function Virtualization Infrastructure (NFVI) in the 5G communication network.

FIG. 12 illustrates an exemplary operation of the 5G communication network.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

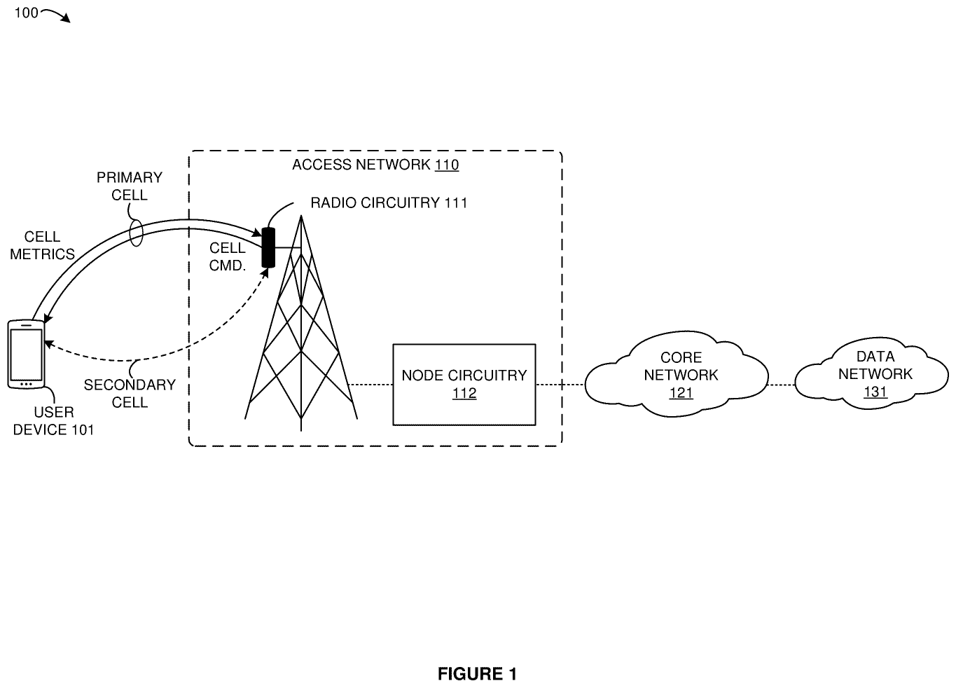

FIG. 1 illustrates wireless communication network 100 to select secondary cells for carrier aggregation. Wireless communication network 100 delivers services like internet-access, media-streaming, online gaming, social media, voice/video calling, machine communications, or some other wireless communications product. Wireless communication network 100 comprises user device 101, access network 110, core network 121, and data network 131. Access network 110 comprises radio circuitry 111 and node circuitry 112. In other examples, wireless communication network 100 may comprise additional or different elements than those illustrated in FIG. 1.

Various examples of network operation and configuration are described herein. In some examples, user device 101 measures signal qualities for the secondary cells served by access network 110. The wireless service provided by access network 110 is organized into cells. The cells correspond to different frequency bands of the bandwidth served by access network 110. Exemplary radio bands include N41, N25, and N71. In carrier aggregation, a device communicates with the access network over multiple cells, one being the primary cell and the other(s) being the secondary cells. User device 101 reports the metrics for the available secondary cells to node circuitry 112 over its primary cell provided by radio circuitry 111. User device 101 may measure a single signal quality for each secondary cell, multiple signal qualities for each secondary cell, a single signal quality type for each secondary cell, or different signal quality types for different secondary cells. Node circuitry 112 compares the signal qualities for the reported secondary cells to a signal quality threshold and identifies cells that exceed the threshold as candidate cells. Node circuitry 112 ranks the candidate cells based on factors like cell load, signal quality, available radio resources, cell suitability for the traffic pattern of the wireless connection, and the like. Node circuitry 112 selects one or more of the secondary cells based on their ranks and transfers a cell command (CMD) to radio circuitry 111 indicating the selected secondary cell(s). Radio circuitry 111 wirelessly transfers the cell command to user device 101 over the primary cell.

Wireless communication network 100 provides wireless data and multimedia services to user device 101. Exemplary user devices include phones, computers, vehicles, robots, and sensors. Access network 110 exchanges wireless signals with user device 101 over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). Access network 110 is connected to core network 121 over backhaul data and signaling links. Access network 110 exchanges network signaling and user data with network elements in core network 121. Access network 110 and core network 121 may communicate via edge networks like internet backbone providers, edge computing systems, or another type of edge system to provide the backhaul data and signaling links between access network 110 and core network 121.

Access network 110 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 121. The CUS handle higher wireless network layers like the Radio Resource Control (RRC), Service Data Adaption Protocol (SDAP), and Packet Data Convergence Protocol (PDCP). The CUs are communicatively coupled to network functions core network 121.

Core network 121 is representative of computing systems that provide wireless data services to user device 101. Exemplary computing systems comprise data centers, server farms, Network Function Virtualization Infrastructure (NFVI), cloud computing networks, hybrid cloud networks, and the like. The computing systems of core network 121 store and execute network functions to provide the wireless data services to user device 101 over access network 110. Exemplary network functions include Access and Mobility Management Function (AMF), Mobility Management Entity (MME), Session Management Function (SMF), and User Plane Function (UPF), Packet Gateway (P-GW), and Serving Gateway (S-GW). Core network 121 may comprise a Sixth Generation Core (6GC), Fifth Generation Core (5GC) architecture, an Evolved Packet Core (EPC) architecture, and the like. Data network 131 is representative of a communication endpoint for user device 101. Data network 131 may comprise another communication network, a content provider, a streaming service, an Application Server (AS), and the like.

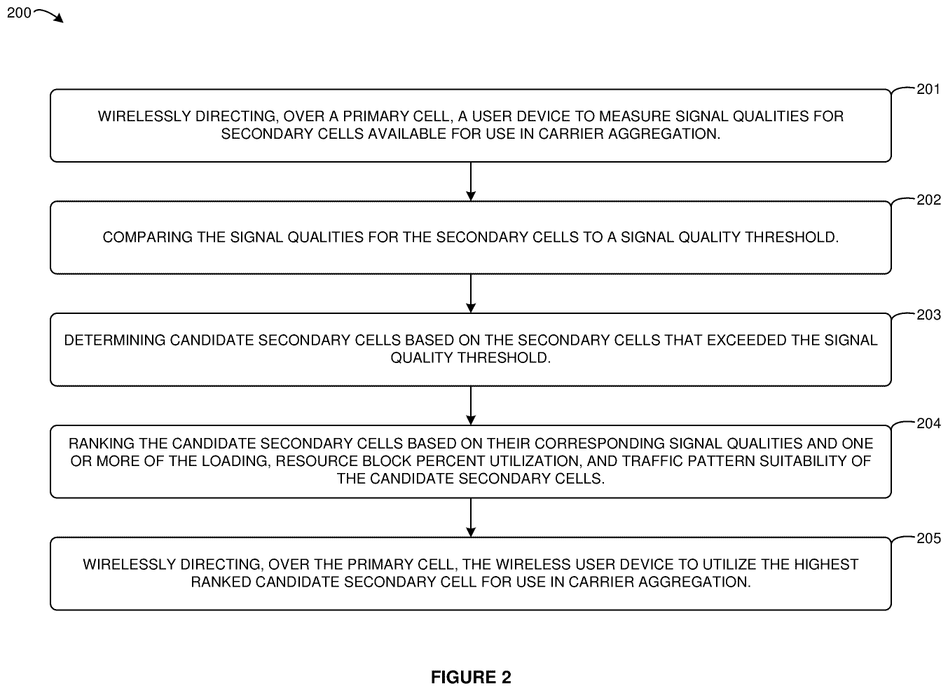

FIG. 2 illustrates process 200. Process 200 comprises an exemplary operation of wireless communication network 100 to select secondary cells for carrier aggregation. The operation may vary in other examples. The operations of process 200 comprise wirelessly directing, over a primary cell, a user device to measure signal qualities for secondary cells available for use in carrier aggregation (step 201). The operations further comprise comparing the signal qualities for the secondary cells to a signal quality threshold (step 202). The operations further comprise determining candidate secondary cells based on the secondary cells that exceeded the signal quality threshold (step 203). The operations further comprise ranking the candidate secondary cells based on their corresponding signal qualities and one or more of the loading, resource block percent utilization, and traffic pattern suitability for the candidate secondary cells (step 204). The operations further comprise wirelessly directing, over the primary cell, the wireless user device to utilize the highest ranked candidate secondary cell for use in carrier aggregation (step 205).

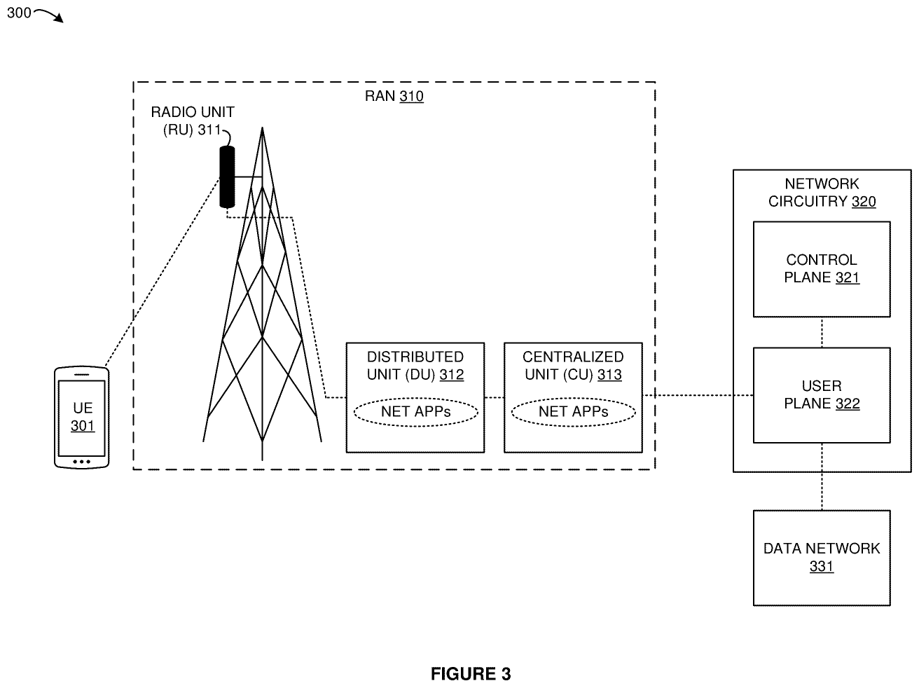

FIG. 3 illustrates wireless communication network 300 network to select secondary cells for carrier aggregation. Wireless communication network 300 is an example of wireless communication network 100, however network 100 may differ. Wireless communication network 300 comprises User Equipment (UE) 301, RAN 310, network circuitry 320, and data network 331. RAN 310 comprises RU 311, DU 312, and CU 313. DU 312 and CU 313 host network applications (NET APPs). Exemplary network applications include RRC, SDAP, PDCP, RLC, MAC, and PHY. Network circuitry 320 comprises control plane 321 and user plane 322. In other examples, wireless communication network 300 may comprise additional or different elements than those illustrated in FIG. 3.

In some examples, RAN 310 selects primary and secondary cells for UE 301 to use for carrier aggregation. In response to UE 301 attaching, RAN 310 directs UE 301 to measure signal quality and signal strength for cells available at UE 301's location. UE 301 measures the available cells and reports the strength/quality in association with cell specific information to RAN 310. Exemplary signal strength/quality measurements include Received Signal Received Power (RSRP) and Received Signal Received Quality (RSRQ). Exemplary cell specific information includes Physical Cell Identifier (PCI) and cell Identifier (ID). In some examples, RAN 310 may direct UE 301 to measure only signal quality (e.g., RSRQ) or only signal strength (e.g., RSRP) for the cells available at UE 301's location. In some examples, RAN 310 may direct UE 301 to measure signal quality for some cells and signal strength for other cells. In some examples, RAN 310 directs UE 301 to measure a single signal metric (e.g., RSRP or RSRQ) for some cells and directs UE 301 to measure multiple signal metrics (e.g., RSRP and RSRQ) for other cells.

RAN 310 receives the cell radio metrics and cell specific information. RAN 310 compares the cell radio metrics to a signal quality threshold to identify candidate secondary cells. For example, RAN 310 may compare reported RSRP for each cell to an RSRP threshold and identify cells that exceeded the threshold as candidate cells. Once the candidates are identified, RAN 310 weights the cells based on their loading, signal strength/quality, Physical Resource Block (PRB) percent utilization, and traffic pattern suitability. RAN 310 weights cells with lower loading higher than cells with higher loading. RAN 310 weights cells with higher signal strength/quality higher than cells with lower signal strength/quality. RAN 310 weights cells with lower PRB percent utilization higher than cells with higher PRB utilization. RAN 310 weights cells more suitable for the traffic pattern (e.g., uplink centric or downlink centric) of the wireless connection higher than cells less suitable for the traffic pattern of the connection. For each candidate, RAN 310 combines the loading weight, signal strength/quality weight, PRB percent utilization weight, and traffic pattern suitability weight into a selection parameter. The selection parameter indicates the candidate cell's overall suitability for use as a secondary cell in carrier aggregation. RAN 310 selects one of more of the candidate secondary cells based on their selection parameters. RAN 310 wirelessly indicates the selected secondary cell(s) to UE 301. UE 301 exchanges signaling and data with RAN 310 using carrier aggregation via the primary and selected secondary cells.

Advantageously, wireless communication network 300 efficiently selects secondary cells for carrier aggregation. Moreover, wireless communication network 300 effectively triggers secondary cell reselection.

UE 301 and RAN 310 communicate over links using wireless/wired technologies like 5GNR, LTE, LP-WAN, WIFI, Bluetooth, and/or some other type of wireless or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface. RAN 310, control plane 321, user plane 322, and data network 331 communicate over various links that use metallic links, glass fibers, radio channels, or some other communication media. The links use Fifth Generation Core (5GC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or some other data communication protocols.

UE 301 comprises a phone, vehicle, computer, sensor, drone, robot, or another type of data appliance with wireless communication circuitry. Although RAN 310 is illustrated as a tower, RAN 310 may comprise another type of mounting structure (e.g., a building), or no mounting structure at all. RAN 310 comprises a Fifth Generation (5G) RAN, LTE RAN, gNodeBs, eNodeBs, NB-IoT access nodes, LP-WAN base stations, wireless relays, WIFI hotspots, Bluetooth access nodes, and/or another wireless or wireline network transceiver. UE 301 and RAN 310 comprise antennas, amplifiers, filters, modulation, analog/digital interfaces, microprocessors, software, memories, transceivers, bus circuitry, and the like. Control plane 321 comprises network functions like AMF, SMF, and the like. User plane 322 comprises network functions like UPF and the like. Data network 331 comprises elements like Application Server (AS) and the like.

UE 301, RAN 310, control plane 321, user plane 322, and data network 331 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, Solid State Drives (SSD), Non-Volatile Memory Express (NVMe) SSDs, Hard Disk Drives (HDDs), and/or the like. The memories store software like operating systems, user applications, radio applications, and network functions. The microprocessors retrieve the software from the memories and execute the software to drive the operation of wireless communication network 300 as described herein.

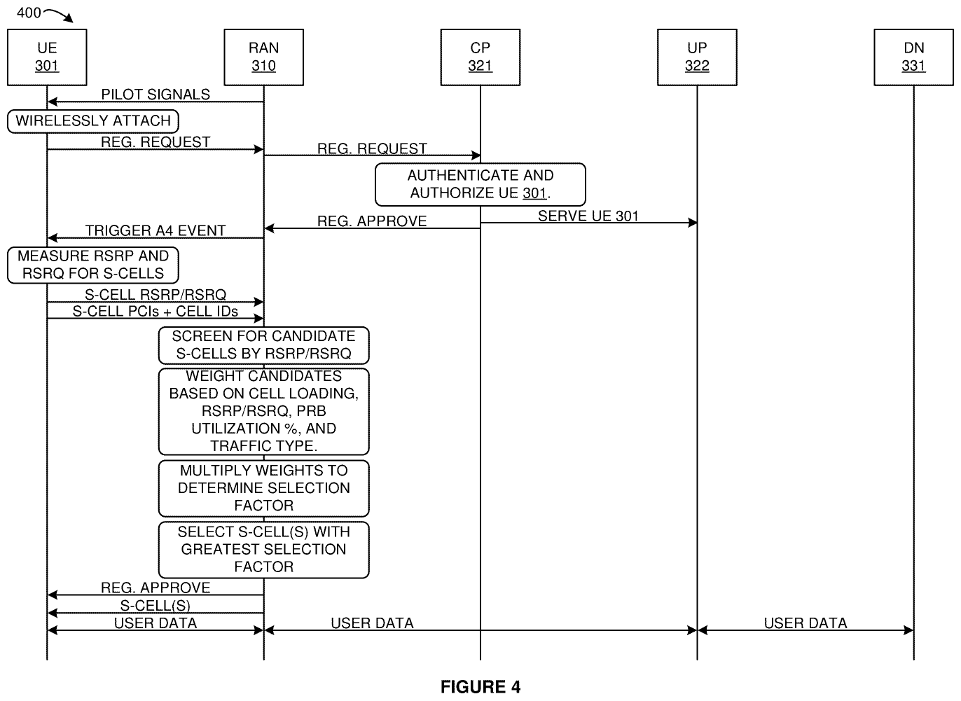

FIG. 4 illustrates process 400. Process 400 comprises an exemplary operation of wireless communication network 300 to select secondary cells for carrier aggregation. Process 400 is an example of process 200 illustrated in FIG. 2, however process 200 may differ. In some examples, CU 313 controls DU 312 and RU 311 to broadcast pilot signals for the cells served by RAN 310. For example, RAN 310 may provide cells that operate in the low, mid, and high frequency bands and RU 311 may broadcast pilot signals for each of the served bands. UE 301 wirelessly receives and measures the pilot signals broadcast by RAN 310 and responsively decides to attach to RAN 310 for wireless data services. UE 301 wirelessly attaches to RAN 310 and exchanges attachment signaling with the network applications hosted by CU 313 and DU 312 to establish a connection on the primary cell between RAN 310 and UE 301. Once the connection is established, UE 301 wirelessly transfers a registration (REG.) request that comprises a measurement report and a capability list for delivery to CU 313. The measurement report indicates RSRP and/or RSRQ for the pilot signals. The capability list indicates frequency band capabilities, Radio Access Technology (RAT) capabilities, a carrier aggregation capability, and/or other capability information for UE 301. CU 313 forwards the registration request to control plane (CP) 321. Control plane (CP) 321 authenticates UE 301 and authorizes UE 301 for wireless data services. Control plane 321 directs user plane (UP) 322 to serve UE 301 and transfers a registration approval message to CU 313.

CU 313 receives the registration approval message and initiates secondary cell (S-CELL) selection for UE 301 to use in carrier aggregation. To select the secondary cell(s), CU 313 transfers a request for delivery to UE 301 to trigger an A4 measurement event. The A4 event is a handover initiation procedure used by UE to determine when radio qualities of a neighbor cell exceed a threshold. The A4 measurement event is defined as:

$$Mn + Ofn + Ocn - Hys > TH \qquad ( 1 )$$

$$Mn + Ofn + Ocn + Hys < TH \qquad ( 2 )$$

where Mn is the measurement result of the neighboring cell, typically an RSRP or RSRQ value, Ofn and Ocn are neighbor cell frequency offsets, Hys is a hysteresis value to prevent ping-pong behavior, and TH is a threshold. Equation (1) is used to determine when the signal quality of the neighbor cell exceeds a threshold to trigger handover while equation (2) is used to determine when the signal quality of the neighbor cell falls below a threshold to cancel handover.

UE 301 wirelessly receives the A4 measurement event request. UE 301 measures RSRP and/or RSRQ for the secondary cells provided by RAN 310. UE 301 wirelessly transfers the RSRP/RSRQ measurements and the PCI and cell ID of the secondary cells for delivery to CU 313. CU 313 identifies each secondary cell available to UE 301 based on the PCIs and cell IDs reported by UE 301. CU 313 compares the RSRP/RSRQ for the identified secondary cells to a threshold(s) to determine candidate cells. CU 313 designates secondary cells with RSRP/RSRQ that exceeded the threshold as candidate cells. In particular, the threshold screens for cells that have sufficient signal strength/quality to serve as secondary cells and excludes secondary cells with insufficient signal strength/quality.

CU 313 determines the loading for each of the candidate secondary cells. For example, CU 313 may determine the number of UE attached to each cell, the number of UEs with Radio Resource Control (RRC) active connections on each cell, number of PDU sessions on each cell, data rate/volume on each cell, or some other type of loading indication. CU 313 bucketizes the candidate secondary cells based on their loading. Each bucket (e.g., category) defines a loading range and is associated with a weighting factor. Exemplary loading ranges include low, medium, and high and may be associated with operator configured loading values. For example, the low loading range may correspond to 0-100 UEs on the cell, the medium loading range may correspond to 101-1000 UEs on the cell, and the high loading range may correspond to more than 1000 UEs on the cell. These numbers are exemplary and may differ in other examples. The weighting factor for each bucket comprises a numeric value that signifies how suitable cells that fall within that bucket are for use as secondary cells in carrier aggregation combinations. The weighting factor for heavily loaded cells is lower than the weighting factor for lightly loaded cells. For example, the low loading range bucket may have a weighting factor of 20, the medium loading range bucket may have a weighting factor of ten, and the high loading range bucket may have a loading range of one.

CU 313 determines the RSRP/RSRQ for each of the candidate secondary cells based on the radio measurements reported by UE 301. Similar to loading, CU 313 bucketizes the candidate cells based on their RSRP/RSRQ values. Each bucket defines a RSRP/RSRQ range and is associated with a weighting factor. Exemplary RSRP/RSRQ ranges include low, medium, and high and may be associated with operator configured RSRP/RSRQ values. For example, the low RSRP range may correspond 0 dbm to −44 dbm, the medium RSRP range may correspond to-45 dbm to −120 dbm, and the high RSRP range may correspond to less than-120 dbm. These numbers are exemplary and may differ in other examples. Like loading, the RSRP/RSRQ weighting factors comprise numeric values that signify the suitability of cells that fall within that bucket. The weighting factor for cells with good RSRP/RSRQ is higher than the weighting factor for cells with poor RSRP/RSRQ. For example, the low RSRP/RSRQ range bucket may have a weighting factor of one, the medium RSRP/RSRQ range bucket may have a weighting factor of ten, and the high RSRP/RSRQ range bucket may have a weighting factor of 20.

CU 313 determines PRB utilization percent for each of the candidate secondary cells. Each cell corresponds to a bandwidth that is divided into a number of PRBs. Cells with larger bandwidth have more PRBs than cells with smaller bandwidth. Each PRB comprises 12 continuous subcarriers in the frequency domain. Data and signaling is encoded into the subcarriers to exchange data and signaling between the UE and the RAN. PRB utilization defines the proportion of PRBs of a cell that are scheduled to carry signaling or data. For example, a cell that is using half of its PRBs to carry signaling/data would have a PRB utilization of 50%. Similar to loading and RSRP/RSRQ, CU 313 bucketizes the candidate cells based on their PRB utilization percents. Each bucket defines a PRB utilization range and is associated with a weighting factor. Exemplary PRB utilization ranges include low, medium, and high and may be associated with operator configured PRB utilization values. For example, the low PRB utilization range may correspond 0-33%, the medium PRB utilization range may correspond to 34-66%, and the high PRB utilization range may correspond to 64-100%. These numbers are exemplary and may differ in other examples. Like loading and RSRP/RSRQ, the weighting factors comprise numeric values that signify the suitability of cells that fall within that bucket. The weighting factor for cells with lower PRB utilization is higher than the weighting factor for cells with higher PRB utilization. For example, the low PRB utilization range bucket may have a weighting factor of 20, the medium PRB utilization range bucket may have a weighting factor of ten, and the high PRB utilization range bucket may have a loading range of 20.

CU 313 determines the traffic profile of the data session of UE 301. In particular, CU 313 determines if the session is uplink driven or downlink driven. CU 313 may determine the traffic profile by tracking the amount of uplink/downlink data exchanged by UE 301 or by the session type requested by UE 301 in the registration request. CU 313 determines cell suitability based on the traffic profile for UE 301's session. Typically, candidate cells that use Frequency Division Duplexing (FDD) are more suitable for uplink driven sessions while candidate cells that use Time Division Duplexing (TDD) are more suitable for downlink driven sessions. When the traffic is uplink driven, CU 313 applies a priority factor to candidate cells that use FDD. When the traffic is downlink driven, CU 313 applies a priority factor to candidate cells that use TDD. The priority factor comprises a multiplier to increase the weighting factors of the loading, RSRP/RSRQ, and PRB utilization buckets.

CU 313 calculates selection factors for each of the candidate cells by multiplying the weighting factors of the buckets the cells are assigned to and if applicable, the priority factor. For example, CU 313 may have assigned a candidate cell to the low loading bucket, high RSRP/RSRQ bucket, and medium PRB utilization bucket and assign the cell a priority factor. The low loading bucket may correspond to a weighting factor of 20, the high RSRP/RSRQ bucket may correspond to a weighting factor of 20, the medium PRB utilization bucket may correspond to a weighting factor of 10, and the priority factor may comprise 2. CU 313 may then calculate the selection factor for the candidate secondary cell by multiplying 20, 20, 10, and 2 to achieve a selection factor of 8,000.

CU 313 selects one of more of the candidate cells based on their selection factors. CU 313 selects candidate secondary cells with higher selection factors over secondary cells with lower selection factors. CU 313 transfers the registration approval message to UE 301. CU 313 includes the selected candidate secondary cell(s) in the registration approval message. UE 301 exchanges user data with user plane 322 over RAN 310 using the primary cell and the selected secondary cell(s). User plane 322 exchanges the user data with data network 331.

While the above example is given in the context of initial cell selection for UE 301, RAN 310 may utilize the above secondary cell selection operation for cell reselection. Secondary cell reselection may be triggered by signal strength deterioration. For example, when attached to RAN 310, UE 301 may periodically measure RSRP/RSRQ of its primary cell and secondary cells and transfer measurement reports comprising the RSRP/RSRQ values to RAN 310. CU 313 may compare the measurements for the secondary cells to a reselection threshold. When the threshold is triggered, CU 313 transfers a request to trigger an A4 measurement to initiate secondary cell selection as described above. Secondary cell reselection may also be triggered by throughput deterioration. For example, when attached to RAN 310, CU 313 may monitor the data throughput of the serving secondary cells for UE 301. CU 313 may compare the data throughput for the secondary cells to a reselection threshold. When the threshold is triggered, CU 313 transfers a request to trigger an A4 measurement to initiate secondary cell selection as described above.

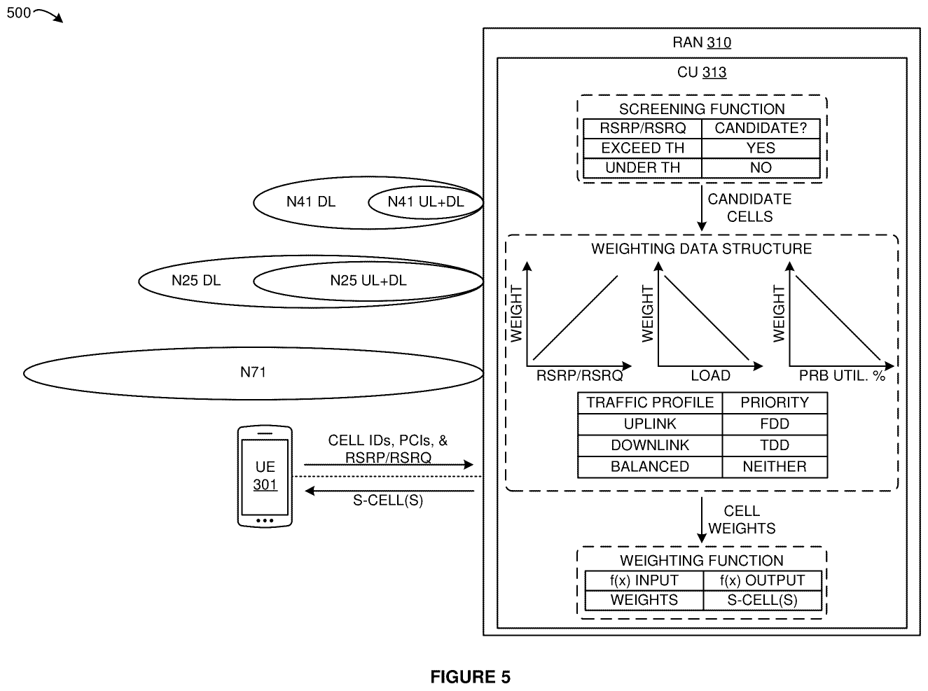

FIG. 5 further illustrates RAN 310 in wireless communication network 300 network. In some examples, RAN 310 provides wireless data services over a set of cells. Each cell corresponds to a different radio band. In this example, the radio bands comprise N41, N25, and N71. N71 is a Frequency Division Duplex (FDD) 5G 600 MHz low-band frequency band. N25 is an FDD 5G 1900 MHz mid-band frequency band. N41 is a Time Division Duplex (TDD) 5G 2500 MHz mid-band frequency band. Other exemplary frequency bands that may be broadcast by RAN 310 include the mid-band FDD 2100 MHZ (N66), the mid-band TDD 3700 MHz (N77), the high-band Millimeter Wave (mmWave) TDD 24 GHz band, and the high-band mmWave 36 GHz band. In carrier aggregation, one of the bands provided by RAN 310 forms the primary cell while one or more of the other bands forms the secondary cell(s). For example, UE 301 may use the N71 band as its primary cell, the N25 downlink (DL) band as a first secondary cell, and the N41 downlink band as a second secondary cell. When UE 301 attaches to RAN 310 or when UE 301 is prompted to perform secondary cell reselection, UE 301 measures RSRP (and/or RSRQ) for the secondary cells provided RAN 310. UE 301 indicates the RSRP/RSRQ, PCI, and cell ID for each cell to RAN 310.

The network applications hosted by CU 313 implement a data structure that implements the screening function, weighting data structure, and weighting function illustrated in FIG. 5. The screening function comprises a table that sorts secondary cells reported by UE 301 and identified by their PCIs and cell IDs into candidate and non-candidate secondary cells. Cells with RSRP/RSRQ that exceed a threshold (TH) are classed as candidates by the screening function while cells that do not exceed the threshold are not classed as candidates. The screening function indicates the PCIs and cell IDs of the candidate cells to the weighting data structure.

The weighting data structure implements the graphs and charts illustrated in FIG. 5 to weight the candidate secondary cells. The x-axes of the graphs comprise RSRP/RSRQ, load, and PRB utilization (UTIL) percent. The y-axes of the graphs comprise weights for the cells. As the RSRP/RSRQ increases for a candidate cell, the weight for that cell also increases. As the load and PRB utilization percent increase for a candidate cell, the weight for that cell decreases. The chart comprises a rule that prioritizes FDD candidate cells or TDD candidate cells based on the traffic profile of UE 301's session. If the traffic profile is uplink centric, FDD cells are prioritized. If the traffic profile is downlink centric, TDD cells are prioritized. If the traffic profile is balanced (e.g., balanced uplink and downlink traffic), traffic profile-based priority may be ignored. The weighting data structure provides the RSRP/RSRQ weight, loading weight, PRB utilization percent weight, and if applicable the traffic profile priority for each candidate cell to the weighting function.

The weighting function comprises an algorithm that takes the RSRP/RSRQ weight, loading weight, PRB utilization percent weight, and traffic profile priority for the candidate cells as input and provides a secondary cell selection as an output. For example, the weighting function may multiply the RSRP/RSRQ weight, loading weight, PRB utilization percent weight, and traffic profile priority for each cell to generate selection factors and then select the secondary cell with the greatest selection factor for UE 301 to use in carrier aggregation. CU 313 indicates the selected secondary cell(s) to UE 301.

The selected secondary cell may comprise the secondary cell UE 301 is currently using for carrier aggregation (e.g., neighbor secondary cells are less suitable than the serving secondary cell) or may comprise a new secondary cell. When the selected cell is the secondary cell serving UE 301, UE 301 remains on that secondary cell. When the selected cell comprises a new secondary cell, CU 313 may select the secondary cell on behalf of UE 301 as described above or may trigger cell swapping using an A6 measurement event. The A6 measurement event is a handover initiation procedure used by UEs to determine when radio qualities of a neighbor cell exceed the radio qualities of a serving secondary cell. The A6 measurement event is defined as:

$$Mn + Ocn - Hys > Ms + Ocs + Off \qquad ( 1 )$$

$$Mn + Ocn + Hys < Ms + Ocs + Off \qquad ( 2 )$$

where Mn is the measurement result of the neighboring cell, Ms is the measurement result of the serving cell, Ocn is the neighbor cell frequency offset, Ocs is the serving cell frequency offset, Hys is a hysteresis value, and Off is the event offset parameter. Equation (1) is used to determine when the signal quality of the neighbor cell exceeds the serving cell to trigger handover while equation (2) is used to determine when the signal quality of the neighbor cell falls below the serving secondary cell to cancel handover. The A6 measurement event may include additional hysteresis values or timers to inhibit ping pong behavior. In some examples, CU 313 determines the serving secondary cell should be swapped (e.g., based on output from the weighting function) and transfers a request to trigger an A6 measurement event to UE 301. In response, UE 301 triggers the A6 event and may switch to a new secondary cell based on the output from the event.

While the above examples with respect to FIGS. 3-5 relate to secondary cell selection and reselection for carrier aggregation provided by a single RAN (e.g., RAN 310), wireless communication network 300 may provide carrier aggregation service to UE 301 over multiple RANs. For example, a first RAN may provide the primary cell to UE 301 while one or more other RANs may provide the secondary cells to UE 301. In a multi-RAN carrier aggregation configuration, the RAN providing the primary cell may select/reselect secondary cells for UE 301 as described above with respect to RAN 310. The primary cell RAN, and the one or more secondary cell RANs may utilize RAN crosslinks (e.g., X2 links) to facilitate and coordinate the above-described secondary cell selection processes. For example, the primary cell RAN may communicate with a secondary cell RAN over X2 links to swap UE 301 to a new secondary cell.

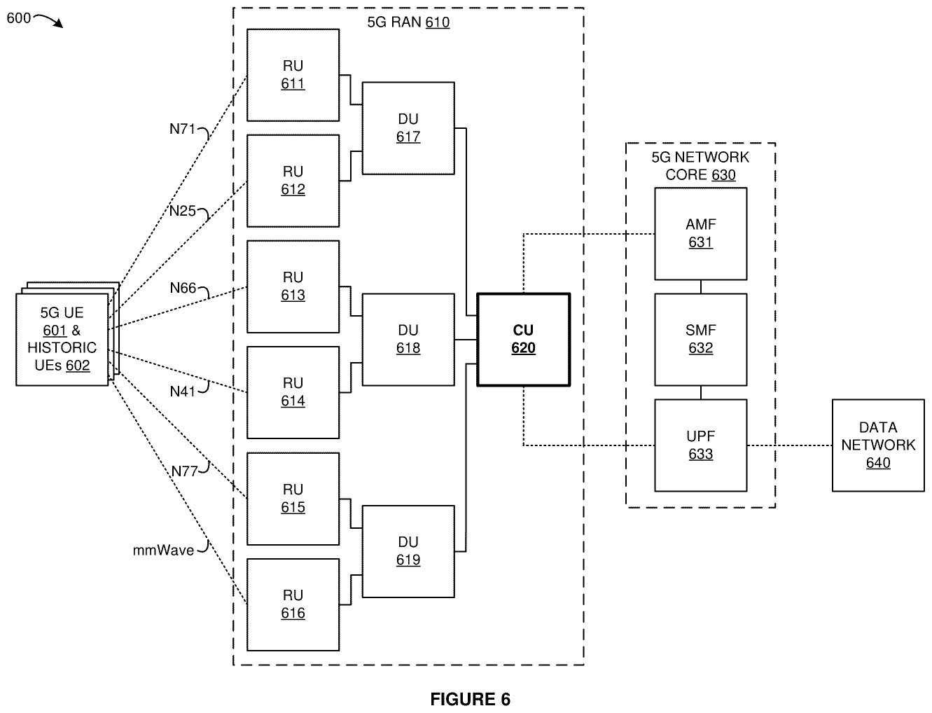

FIG. 6 illustrates 5G communication network 600 to select secondary cells for carrier aggregation. 5G communication network 600 comprises an example of networks 100 and 300, although networks 100 and 300 may differ. 5G communication network 600 comprises 5G UE 601, historic UEs 602, 5G RAN 610, 5G network core 630, and data network 640. 5G RAN 610 comprises RUs 611-616, DUs 617-619, and CU 620. Network core 630 comprises AMF 631, SMF 632, and UPF 633. Data network 640 comprises elements like AS. Other network functions and network elements like Authentication Server Function (AUSF), Network Slice Selection Function (NSSF), Policy Control Function (PCF), Unified Data Management (UDM), Unified Data Repository (UDR), Network Repository Function (NRF), Equipment Identity Register (EIR), Session Communication Proxy (SCP), Network Exposure Function (NEF), and Application Function (AF) are typically present in 5G network core 630 but are omitted for clarity. In other examples, 5G communication network 600 may comprise different or additional elements than those illustrated in FIG. 6.

In some examples, RUs 611-616 correspond to different cells that may be used for carrier aggregation to serve UE 601. RU 611 provides the N71 band, RU 612 provides the N25 band, RU 613 provides the N66 band, RU 614 provides the N41 band, RU 615 provides the N77 band, and RU 616 provides a mmWave band (e.g., 24 GHz or 36 GHz). Each band comprises contiguous and non-contiguous carriers of various channel bandwidths. CU 620 controls DUs 617-619 to broadcast System Information Blocks (SIBs) from RUs 611-616. The SIBs indicate the bands served by each of RUs 611-616 as well as band priority for their respective frequency bands. For example, the SIB broadcast by RU 611 may identify N71 as the band served by RU 611 and the attachment priority for the N71 band with respect to the other bands served by RUs 612-616.

Historic UEs 602 are representative of UEs served by RAN 610 over time. Historic UEs 602 attach to RAN 610 and register with network core 630 for wireless data services. The network functions of core 630 interface with each other to authenticate and authorize historic UEs 602 for wireless data services. Responsive to authentication and authorization, core 630 registers historic UEs 602 and directs RAN 610 to serve historic UEs 602. RAN 610 assigns primary and secondary cell carrier aggregation band combinations for historic UEs 602. RAN 610 exchanges user data and signaling with historic UEs 602 over the primary/secondary cells served by RU 611-RU 616.

As RAN 610 serves historic UEs 602, CU 620 tracks performance metrics of the cell combinations. CU 620 solicits RSRP, RSRQ, PCI, and cell ID from UEs 602 for their respective cells. CU 620 determines cell loading and PCB percent utilization for the cells based on the PCIs and cell IDs reported by historic UEs 602. CU 620 determines which cells used by UEs 602 are FDD and which cells are TDD. CU 620 calculates the geographic locations for historic UEs 602 (e.g., via solicitation, beamforming and timing data, triangulation, etc.). CU 620 measures the throughput and latency for the data sessions of historic UEs 602 over their respective cells. For each of historic UEs 602, CU 620 generates a session profile detailing the performance of the cell combination used by each of historic UEs 602 in their respective sessions. The profiles store data indicating PCI and cell ID for the primary cell and secondary cells, RSRP, RSRQ, loading, PCB percent utilization, geographic location, throughput, and latency to generate session performance metrics. CU 620 may provide the session profiles to a database for long term storage.

CU 620 hosts a machine learning model trained to select secondary cells for carrier aggregation. The machine learning model comprise any machine learning model or artificial intelligence system implemented within network 600 trained to select secondary cells/trigger secondary cell reselection based on UE location. A machine learning model comprises one or more artificial intelligence/machine learning algorithms that are trained based on historical data and/or other types of training data associated with wireless communication networks. A machine learning model may employ one or more machine learning algorithms through which data can be analyzed to identify patterns, make decisions, make predictions, or similarly produce output. Examples of machine learning algorithms that may be employed solely or in conjunction with one another include Large Language Models (LLMs), Three Dimensional (3D) deep leaning models, 3D convolutional neural networks, times series convolutional deep learning, transformers, multi-layer perceptron, long term short memory, and attention based deep learning model. Other exemplary machine learning algorithms include artificial neural networks, nearest neighbor methods, ensemble random forests, support vector machines, naïve Bayes methods, linear regressions, or similar machine learning techniques or combinations thereof capable of predicting output based on input data.

To train the machine learning model, CU 620 accesses the session profiles that characterize the performance of the cell combinations used by historic UEs 602. CU 620 converts the data stored in the session profiles like cell ID and PCI for the primary and secondary cells, RSRP, RSRQ, loading, PCB percent utilization, geographic location, throughput, and latency into feature vectors. Feature vectors comprise numeric representations of data interpretable by machine learning models. For example, CU 620 may generate integers that represent the geographic locations of one of historic UEs 602 during its data session and then group the integers into a feature vector representing the location of that historic UE. During training, CU 620 provides the feature vectors to the machine learning model to train its constituent algorithms to select secondary cells based on UE location. The model's algorithms learn which secondary cell(s) provide optimal service in the various locations served by RAN 610 based on the PCIs, cell IDs, RSRP, RSRQ, cell loading, PCB utilization, FDD/TDD type, throughput, and latency reported by historic UEs 602. The training process is typically an unsupervised training process, however other machine learning training techniques may be used. Once trained, CU 620 activates the machine learning model. It should be appreciated that the training process may be continued once the model is activated to advance the training of the model's algorithms over time.

Subsequently, CU 620 controls DUs 617-619 to broadcast SIBs from RUs 611-616. 5G UE 601 wirelessly receives the SIBs broadcast by RAN 610 and measures RSRP and RSRQ for the SIBs. UE 601 wirelessly attaches to RAN 610 via one of RUs 611-616 based on the attachment priority indicated in the SIBs and/or measured radio metrics. UE 601 exchanges attachment signaling with CU 620 over the attached to RU and DU to establish a Radio Resource Control (RRC) connection with the radio applications hosted by CU 620. Once the RRC connection is established, UE 601 wirelessly transfers a registration request for delivery to CU 620. The registration request includes information like a registration type, 5G-Global Unique Temporary Identifier (GUTI), UE capabilities, Network Slice Selection Assistance Information (NSSAI) requests, Protocol Data Unit (PDU) session requests, and the like. The UE capabilities indicate that UE 601 can utilize carrier aggregation.

CU 620 forwards the registration request for UE 601 to AMF 631. In response to the registration request, AMF 631 transfers an identity request to UE 601 over RAN 610. UE 601 indicates its Subscriber Concealed Identifier (SUCI) to AMF 631 over RAN 610. AMF 631 interfaces with other network functions like AUSF and UDM to authenticate UE 601. In particular, AMF 631 retrieves authentication vectors including an authentication challenge, key selection criteria, and a random number as well as the Subscriber Permanent Identifier (SUPI) for UE 601. AMF 631 indicates the authentication type and transfers the authentication challenge, key selection criteria, and random number to UE 601 over RAN 610. UE 601 hashes the random number using its copy of the secret key to generate an authentication response and transfers the response to AMF 631 over RAN 610. AMF 631 matches the authentication response to the expected result to authenticate UE 601.

Responsive to the authentication, AMF 631 interacts with other network functions like NSSF and UDM to select network slices for UE 601 and generate UE context. AMF 631 interacts with other network functions like PCF to select network policies for UE 601. The UE context comprises data like supported features, slice selection information, PDU session information, QoS metrics, service attributes, and the like. AMF 631 selects SMF 632 to establish the requested PDU sessions for UE 601 based on the UE context. SMF 632 selects UPF 633 to establish the PDU session for UE 601. SMF 632 informs AMF 631 that the session context for the PDU session has been created. AMF 631 transfers a registration accept message that comprises the UE context to CU 620.

In response to the registration accept message, CU 620 determines the geographic location of UE 601. For example, CU 620 may solicit UE 601 to report its location or may cross-reference the location of UE 601 based on the timing advance signal between UE 601 and RAN 610 with beam direction information (e.g., serving beam ID). Alternatively, UE 601 may include its location in the original registration request and CU 620 may cache the UE location before forwarding the request to AMF 631. CU 620 converts the location of UE 601 into a feature vector and provides the feature vector to the machine learning model. The machine learning model processes the vector using its constituent algorithms trained to select secondary cells based on UE location and generates a machine learning output. The machine learning output indicates a list of secondary cells for UE 601 to use for carrier aggregation. CU 620 assesses current network conditions for the listed secondary cells and selects one or more of the cells to serve UE 601. For example, CU 620 may determine loading and PRB utilization for the listed cells and select cells with low loading and/or low PRB utilization.

CU 620 indicates the selected primary and secondary cells in the registration accept message. CU 620 transfers the registration accept message for delivery to UE 601. UE 601 identifies the primary cell and the secondary cell(s). UE 601 establishes wireless links with ones of RUs 611-616 that correspond to the selected primary and secondary cells. For example, if the secondary cell is in the N41, UE 601 may establish a wireless connection with RU 614. UE 601 exchanges user data over the primary/secondary cells with CU 620 over the corresponding ones of RUs 611-616 and DUs 617-619 based on the UE context. CU 620 exchanges the user data with UPF 633. UPF 633 exchanges the user data with data network 640.

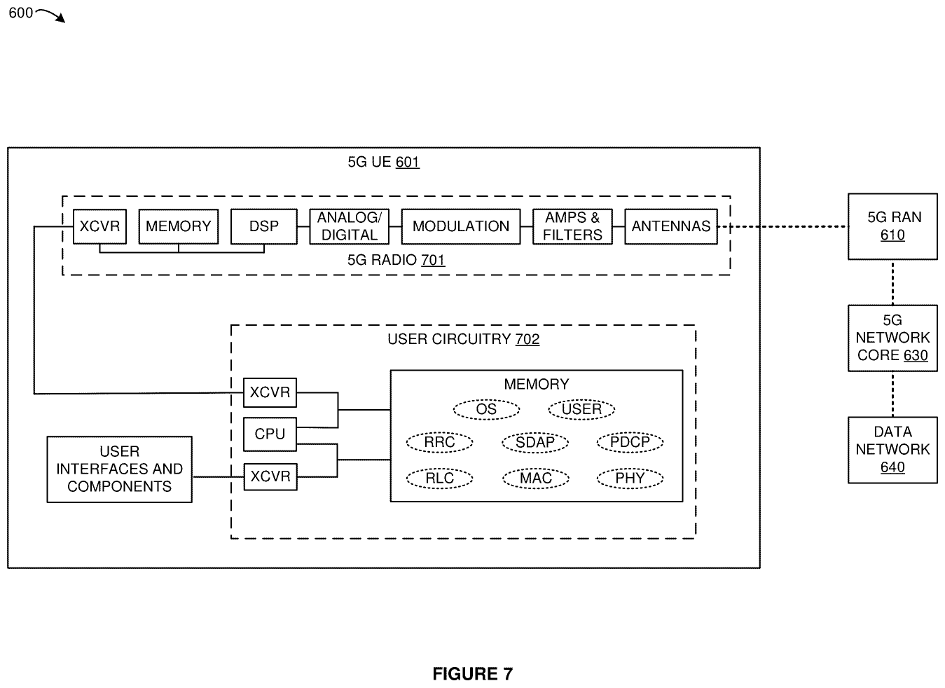

FIG. 7 illustrates 5G UE 601 in 5G communication network 600. UE 601 comprises an example of user device 101 illustrated in FIG. 1 and UE 301 illustrated FIG. 3, however user device 101 and UE 301 may differ. Historic UEs 602 comprise similar architectures to UE 601. UE 601 comprises 5G radio 701 and user circuitry 702. Radio 701 comprises antennas, amplifiers, filters, modulation, analog-to-digital interfaces, Digital Signal Processers (DSP), memory, and transceivers (XCVRs) that are coupled over bus circuitry. User circuitry 702 comprises memory, CPU, user interfaces and components, and transceivers that are coupled over bus circuitry. The memory in user circuitry 702 stores an operating system (OS), user applications (USER), and 5GNR network applications for Physical Layer (PHY), Media Access Control (MAC), Radio Link Control (RLC), Packet Data Convergence Protocol (PDCP), Service Data Adaptation Protocol (SDAP), and Radio Resource Control (RRC). The antenna in radio 701 is wirelessly coupled to 5G RAN 610 over a 5GNR link. A transceiver in radio 701 is coupled to a transceiver in user circuitry 702. A transceiver in user circuitry 702 is typically coupled to the user interfaces and components like displays, controllers, and memory.

In radio 701, the antennas receive wireless signals from 5G RAN 610 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 702 over the transceivers. In user circuitry 702, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In radio 701, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 610 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

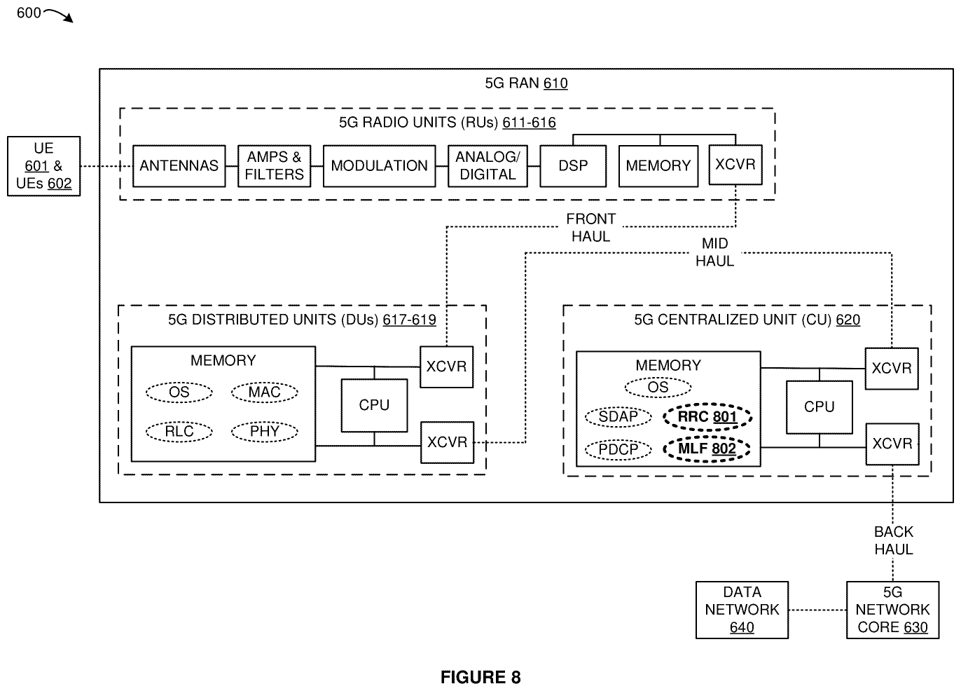

FIG. 8 illustrates 5G RAN 610 in 5G communication network 600. RAN 610 comprises an example of access network 110 illustrated in FIG. 1 and RAN 310 illustrated in FIG. 3, however access network 110 and RAN 310 may differ. RUs 611-616 comprise antennas, amplifiers, filters, modulation, analog-to-digital interfaces, DSP, memory, and transceivers (XCVRs) that are coupled over bus circuitry. The antennas in RUs 611-616 are wirelessly coupled to UE 601 over 5GNR links. Transceivers in 5G RUs 611-616 are coupled to transceivers in 5G DUs 617-619 over fronthaul links like enhanced Common Public Radio Interface (eCPRI). The DSPs in RUs 611-616 execute their operating systems and radio applications to exchange 5GNR signals with UE 601 and to exchange 5GNR data with DUs 617-619.

For the uplink, the antennas receive wireless signals from UE 601 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DUs 617-619 over the transceivers.

For the downlink, the DSPs receive downlink 5GNR symbols from DUs 617-619. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 601 that transport the downlink 5GNR signaling and data.

DUs 617-619 comprise memory, CPU, and transceivers that are coupled over bus circuitry. The memory in 5G DUs 617-619 store operating systems and 5GNR network applications like PHY, MAC, and RLC. CU 620 comprises memory, CPU, and transceivers that are coupled over bus circuitry. The memory in CU 620 stores an operating system and 5GNR network applications like PDCP, SDAP, RRC 801, and Machine Learning Function (MLF) 802. Transceivers in 5G DUs 617-619 are coupled to transceivers in RUs 611-616 over front-haul links. Transceivers in DUs 617-619 are coupled to transceivers in CU 620 over mid-haul links. A transceiver in CU 620 is coupled to network core 630 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC 801 functions include authentication, security, handover control, status reporting, QoS, network broadcasts and pages, network selection, and machine learning model interfacing. MLF 802 functions include machine learning location based secondary cell recommendation.

In some examples, as RAN 610 serves historic UEs 602, RRC 801 collects training data like cell ID and PCI for the primary and secondary cells used by historic UEs 602, RSRP, RSRQ, loading, PCB percent utilization, geographic location, throughput, and latency. RRC 801 converts the training data into feature vectors and provides the feature vectors to MLF 802. MLF 802 trains its constituent machine learning model to select secondary cells for carrier aggregation based on UE location.

RRC 801 in CU 620 receives attachment signaling from UE 601. RRC 801 participates in a RACH procedure to assign radio resources to UE 601 for registration communications. RRC 801 receives an RRCSetupRequest message from UE 601. In response, RRC 801 transfers an RRCSetup message for delivery to UE 601 to establish an RRC connection between the RRC in UE 601 and RRC 801. The RRCSetup message includes radio bearer configuration and cell information for UE 601 to use to establish the RRC connection. RRC 801 receives an RRCSetupComplete message from UE 601 that includes a measurement report for RUs 611-616 and registration request. The registration request indicates carrier aggregation capabilities of UE 601. RRC 801 forwards the registration request to AMF 631.

When UE 601 is successfully registered by network core 630, RRC 801 receives a registration accept message for UE 601 from AMF 631. In response, RRC 801 determines the location of UE 601. RRC 801 cross-references beam timing data (e.g., the timing advance signal) with beamforming direction data (e.g., beam ID) to determine the location of UE 601. The timing data indicates the amount of time it takes for signals to travel between UE 601 and RAN 610 over the serving primary cell. The beamforming direction data indicates the azimuth and altitude of UE 601 with respect to the coordinate system of RAN 610 (e.g., UE 601's location within the serving cell). The RAN coordinate system is a radial coordinate system where RAN 610 is the center point and the vector that defines the serving cell center is the 0° axis. RRC 801 may convert UE 601's position defined in the RAN coordinate system to a latitude, longitude, and elevation. For example, UE 601 may initially attach to RAN 610 over the N71 cell provided by RU 611. RRC 801 may process the timing advance signal between UE 601 and RU 611 as well as the beam ID used by RU 611 to communicate with UE 601 to determine location of UE 601 within the cell provided by RU 611. RRC 801 converts the location of UE 601 into a feature vector and provides the feature vector to MLF 802. MLF 802 processes the feature vector using its model trained to select secondary cells based on UE location and returns a machine learning output that indicates a list of candidate secondary cells for UE 601.

RRC 801 interfaces with the MAC in the serving one of DUs 617-619 to select one or more of the candidate secondary cells indicated by MLF 802. RRC 801 generates and transfers a RRCReconfiguration message that includes the primary cell ID, the selected secondary cell IDs, and the registration accept message for delivery to UE 601. RRC 801 receives an RRCReconfigurationComplete message generated by UE 601 indicating that UE 601 has successfully established radio connections with the primary and secondary cells. RRC 801 directs the SDAP to serve UE 601. The SDAP drives the lower-level radio applications (e.g., PDCP, RLC, MAC, and PHY) to exchange user data for the PDU session with UE 601 over the primary and secondary cells selected by RRC 801. The SDAP exchanges the user data with UPF 633.

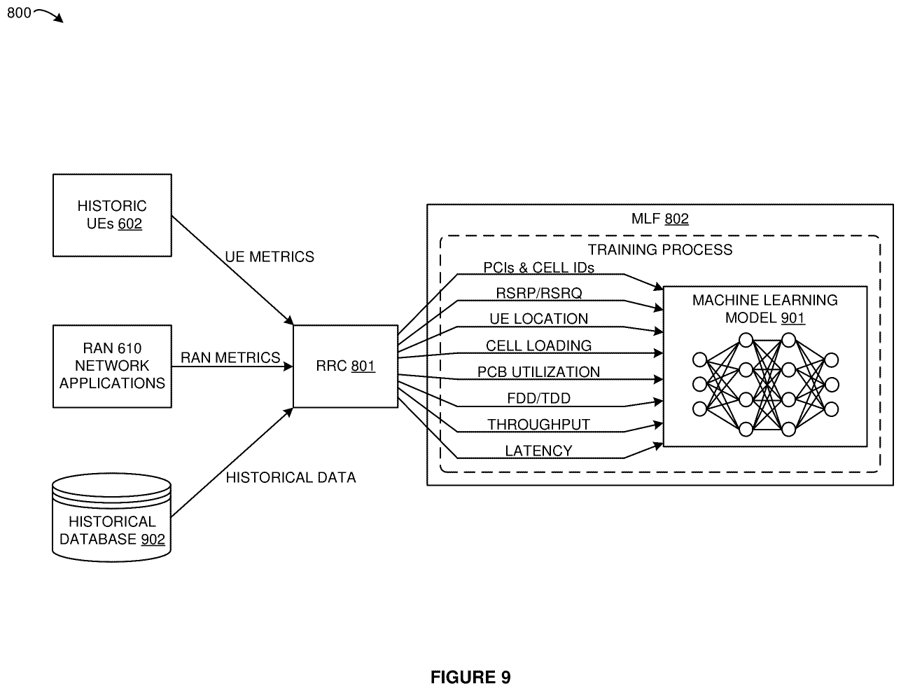

FIG. 9 further illustrates RAN 610 to train MLF 802 to select secondary cells based on UE location. MLF 802 comprise machine learning model 901. In some examples, RRC 801 collects UE metrics that characterize the performance of the secondary cells as RAN 610 serves historic UEs 602. The UE metrics include RSRP, RSRQ, PCI, cell ID, UE location. Additional UE metrics that may be used to train MLF 802 include Signal-to-Noise Ratio (SINR), power headroom, transmit power, and the like. RRC 801 interfaces with the other network applications hosted by RAN 610 like SDAP, PDCP, RLC, MAC, and PHY to collect RAN metrics that characterize the performance of the secondary cells used by historic UEs 602. The RAN metrics include FDD/TDD type, cell loading, PCB utilization percent, throughput, and latency. Additional RAN metrics that may be used to train MLF 801 include downlink data queuing, PDU session type, network slice identifiers like Signal Network Slice Selection Assistance Information (S-NSSAI), and the like. RAN 801 collects historic data that indicates past performance of the secondary cells from historical database 902. The historic data comprises geo-tagged measurements for RSRP, RSRQ, SINR, and the like. To train machine learning model 901, RRC 801 converts the UE metrics, RAN metrics, and historical data into feature vectors and provides the feature vectors to MLF 802. In this example, the feature vectors include PCIs and cell IDs for the secondary cells, RSRP/RSRQ, UE location, cell loading, PCB utilization, FDD/TDD type, throughput, and latency. In other examples, the feature vectors may characterize additional or different data that characterize the performance of the secondary cells (e.g., SINR, transmit power, slice type, PDU session type, etc.). MLF 802 provides the feature vectors to model 901. Model 901 ingests the vectors and undergoes an unsupervised training process to train its algorithms to select secondary cells based on UE location. For example, the algorithms of model 901 may learn the optimal secondary cells for the geographic locations served by RAN 610 based on the RSRP/RSRQ, loading, PCB utilization, FDD/TDD cell type, throughput, and latency associated with the locations.

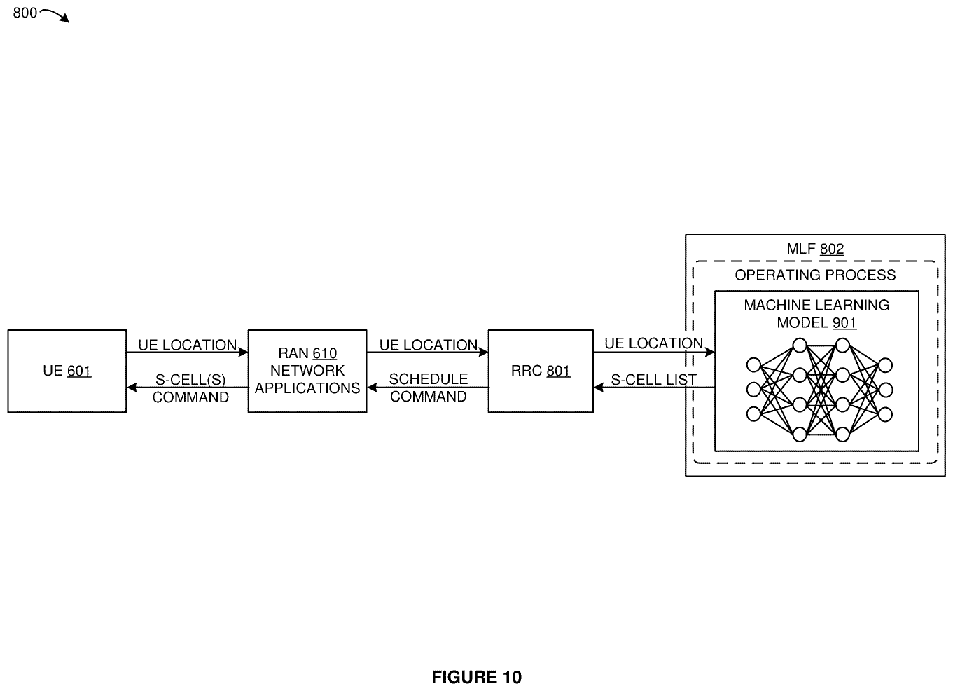

FIG. 10 further illustrates RAN 610 to implement model 901 after initial training is complete to select secondary cells based on UE location. In some examples, RRC 801 interfaces with the other network applications in RAN 610 to determine the location of UE 601. RRC 801 may determine the location of UE 601 by solicitation, cross-referencing beam timing and beam direction data, triangulation, and the like. RRC 801 converts the location of UE 601 into a feature vector and transfers the feature vector to MLF 802. MLF 802 feeds the feature vector to model 901. Model 901 processes the feature vector using its algorithms trained to select secondary cells based on UE location and generates a machine learning output. The output comprises a list of secondary cells for UE 601. MLF 802 transfers the secondary cell list to RRC 801. RRC 801 interfaces with the other network applications in RAN 610 (e.g., the MAC) to select one or more of the listed secondary cells based on current cell conditions (e.g., loading, PCB utilization, etc.). RRC 801 directs the other network applications to schedule UE 601 for service on the selected secondary cell(s). The other network applications schedule UE 601 for service on the secondary cell(s) and indicate the selected secondary cell(s) to UE 601. Although RRC 801 is illustrated in FIGS. 8-10 as generating feature vectors and interfacing with MLF 802, in some examples RAN 610 may include a machine learning interface application to handle communications with MLF 802 and feature vector generation as described above for RRC 801.

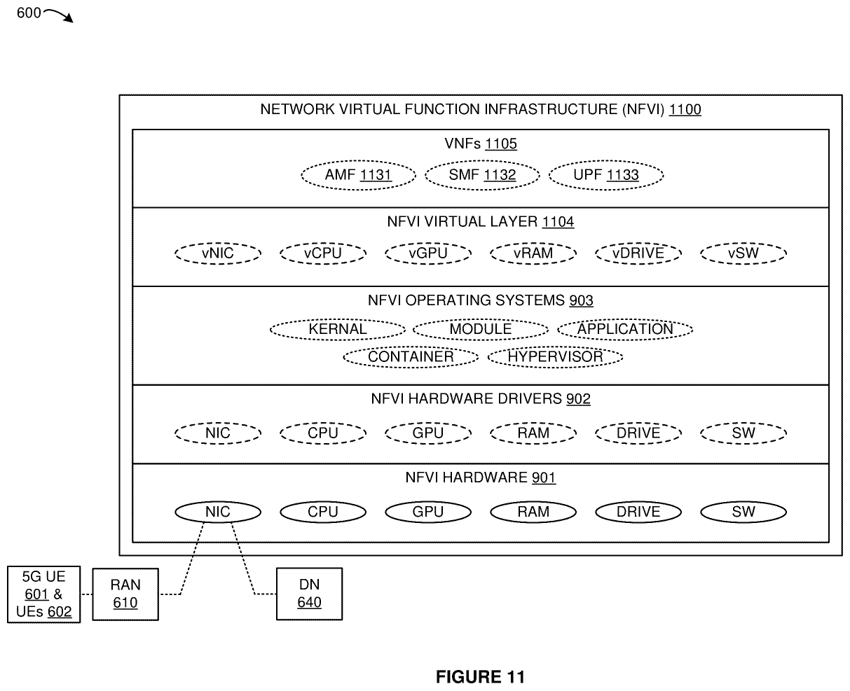

FIG. 11 illustrates Network Function Virtualization Infrastructure (NFVI) 1100. NFVI 1100 comprises an example of core network 121 illustrated in FIG. 1 and network circuitry 320 illustrated in FIG. 3, however core network 121 and network circuitry 320 may differ. NFVI 1100 comprises NFVI hardware 1101, NFVI hardware drivers 1102, NFVI operating systems 1103, NFVI virtual layer 1104, and NFVI Virtual Network Functions (VNFs) 1105. NFVI hardware 1101 comprises Network Interface Cards (NICs), CPU, GPU, RAM, Flash/Disk Drives (DRIVE), and Data Switches (SW). NFVI hardware drivers 1102 comprise software that is resident in the NIC, CPU, GPU, RAM, DRIVE, and SW. NFVI operating systems 1103 comprise kernels, modules, applications, containers, hypervisors, and the like. NFVI virtual layer 1104 comprises vNIC, vCPU, vGPU, vRAM, vDRIVE, and vSW. NFVI VNFs 1105 comprise AMF 1131, SMF 1132 and UPF 1133. Additional VNFs and network elements like AUSF, NSSF, PCF, UDM, UDR, NRF, EIR, SCP, NEF, and AF are typically present but are omitted for clarity. NFVI 1100 may be located at a single site or be distributed across multiple geographic locations. The NIC in NFVI hardware 1101 is coupled to RAN 610 and data network 1140. NFVI hardware 1101 executes NFVI hardware drivers 1102, NFVI operating systems 1103, NFVI virtual layer 1104, and NFVI VNFs 1105 to form AMF 631, SMF 632, and UPF 633.

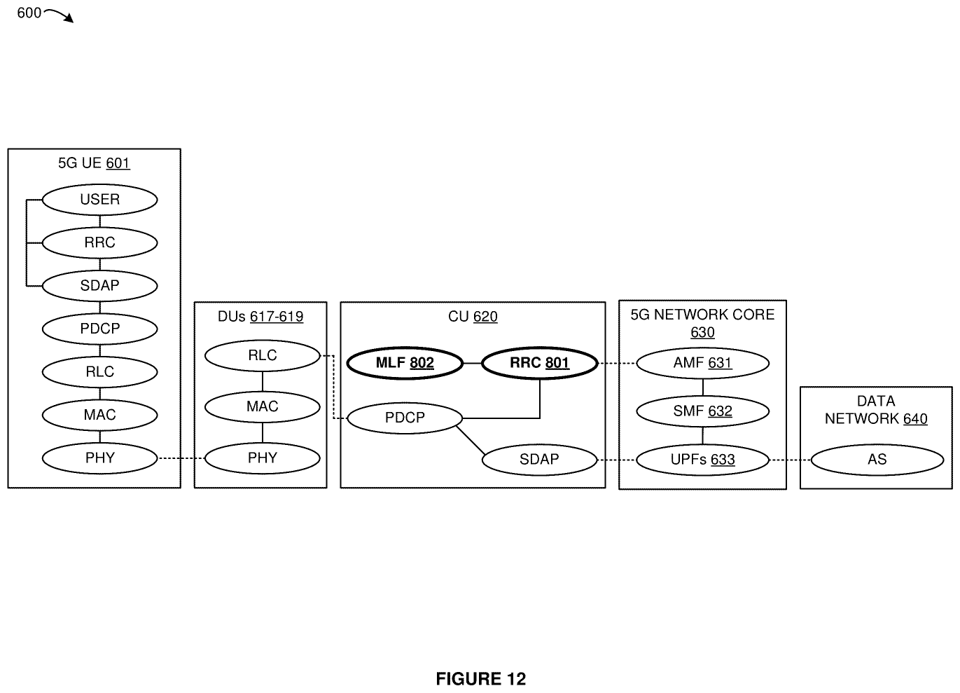

FIG. 12 illustrates an exemplary operation of 5G communication network 600 to select secondary cells for carrier aggregation. The operation may vary in other examples. In some examples, the RRC in UE 601 controls the PDCP, RLC, MAC, and PHY to attach to the N71 cell provided by RU 611. Upon attachment, the RRC initiates a RACH procedure with RRC 801 over the PDCPs, RLCs, MACs, and PHYs to assign radio resources for network registration. Once the RACH procedure is complete, the RRC in UE 601 transfers an RRCSetupRequest message to RRC 801 over the PDCPs, RLCs, MACs, and PHYs. RRC 801 receives the request and selects bearer configuration and cell information for UE 601. RRC 801 transfers an RRCSetup message to the RRC in UE 601 that includes the bearer configuration and cell information to establish the RRC connection. The RRC in UE 601 establishes the RRC connection using the information received in the setup message. The RRC generates an RRCSetupComplete message that includes a registration request. The registration request comprises the 5G GUTI, UE capabilities, NSSAI requests, and PDU session requests. The RRC transfers the RRCSetupComplete message to RRC 801 over the PDCPs, RLCs, MACs, and PHYs. RRC 801 forwards the registration request to AMF 631.

In response to the registration request, AMF 631 transfers an identity request for UE 601 to RRC 801. RRC 801 forwards the identity request to the RRC in UE 601 over the PDCPs, RLCs, MACs, and PHYs. The RRC in UE 601 responds to the request by indicating its SUCI to RRC 801 over the PDCPs, RLCs, MACs, and PHYs. RRC 801 forwards UE 601's SUCI to AMF 631. AMF 631 interacts with other network functions to retrieve authentication vectors to validate the identity of UE 601. The vectors comprise an authentication challenge, key selection criteria, a random number, and the SUPI for UE 601. AMF 631 transfers a Non-Access Stratum (NAS) Authentication Request that includes the authentication type, the authentication challenge, key selection criteria, and random number to RRC 801. RRC 801 forwards the NAS Authentication Request to the RRC in UE 601 over the PDCPs, RLCs, MACs, and PHYs. The RRC in UE 601 hashes the random number using its copy of the secret key to generate an authentication response parameter. The RRC transfers a NAS Authentication Response message that includes the authentication response parameter generated by UE 601 to RRC 801 over the PDCPs, RLCs, MACs, and PHYs. RRC 801 forwards the NAS Authentication Response to AMF 631. AMF 631 matches the authentication response parameter to the expected result to authenticate UE 601. Responsive to the authentication, AMF 631 interacts with other network functions to generate UE context and select network policies for UE 601. AMF 631 selects SMF 632 to establish the requested PDU sessions for UE 601 based on the UE context. SMF 632 selects UPF 633 to establish the PDU session for UE 601. SMF 632 informs AMF 631 that the session context for the PDU session has been created. AMF 631 transfers a registration accept message to RRC 801.

RRC 801 receives the registration accept message for UE 601 from AMF 631. RRC 801 cross-references beam timing data and beam direction data between RU 611 and UE 601 to determine the location of UE 601 within the N71 cell. RRC 801 converts cell location of UE 601 into latitude, longitude, and elevation of UE 601. RRC 801 forms a feature vector to numerically represent the latitude, longitude, and elevation of UE 601 and provides the feature vector to MLF 802. MLF 802 processes the feature vector using machine learning model 901. MLF 802 returns a machine learning output comprising a list of candidate secondary cells to RRC 801. In this example, the candidate cells comprise the N25 provided by RU 612 and the N66 provided by RU 613. RRC 801 interfaces with the SDAP, PDCP, RLC, MAC, and PHY to determine current loading and PCB utilization for the N25 and N66. In this example, the N25 has lower loading and PCB utilization than the N66. In response, RRC 801 selects the N25 as the secondary cell and directs the MAC in DU 617 to schedule UE 601 for service on the N25.

RRC 801 generates a RRCReconfiguration message that indicates the N25 as the selected secondary cell and includes the registration accept message for UE 601. RRC 801 transfers the RRCReconfiguration message to the RRC in UE 601 over the PDCPs, RLCs, MACs, and PHYs. The RRC in UE 601 receives the RRCReconfiguration message and identifies the N25 as the selected secondary cell to use for carrier aggregation. Since RU 612 provides the N25 band, the RRC drives the PDCP, RLC, MAC, and PHY to establish wireless links with RU 612. The RRC transfers an RRCReconfigurationComplete message for delivery to RRC 801 over the PDCPs, RLCs, MACs, and PHYs indicating that UE 601 has successfully established radio connections with the N25.

UE 601 begins the PDU session. A user application in UE 601 generates uplink data for the PDU session. The RRC in UE 601 directs the SDAP to exchange data for the PDU session. The SDAP transfers the uplink data for the PDU session to the SDAP in CU 620 over the PDCPs, RLCs, MACs, and PHYs using the primary N71 cell and the secondary N25 cell (e.g., by carrier aggregation). The SDAP in CU 620 transfers the uplink data to UPF 633. UPF 633 transfers the uplink data to the AS in data network 640. The AS generates downlink data for the PDU session and transfers the downlink data to UPF 633. UPF 633 transfers the downlink data to the SDAP in CU 620. The SDAP in CU 620 transfers the downlink data to the SDAP in UE 601 over the PDCPs, RLCs, MACs, and PHYs using the primary N71 cell and the secondary N25 cell.

As UE 601 participates in its PDU session, the RRC in UE 601 drives the PHY to periodically measure RSRP and RSRQ for the serving N71 and N25 cells to detect handover conditions. The PHY measures the RSRP and RSRQ for the N71 and N25 and indicates the measurements to the RRC. The RRC generates a measurement report comprising the RSRP and RSRQ values and transfers the measurement report to the RRC 801 over the PDCPs, RLCs, MACs, and PHYs. Contemporaneously, RRC 801 drives the SDAP in CU 620 to monitor data throughput for UE 601's PDU session. The SDAP measures downlink/uplink data throughput of the PDU session and indicates the throughput measurements to RRC 801.

RRC 801 receives the measurement report generated by UE 601 and the throughput measurements from the SDAP in CU 620. RRC 801 compares RSRP and RSRQ to signal strength and signal quality thresholds. RRC 801 compares the data throughput to a data throughput threshold. RRC 801 determines that the RSRP, RSRQ, and/or data throughput for UE 601 have dropped below the threshold values. For example, UE 601 may have moved to a new location causing its signal quality on the N25 to diminish. In response to triggering at least one of the deterioration thresholds, RRC 801 recalculates the location of UE 601 based on updated beam timing data and updated beam direction data between RU 611 and UE 601. RRC 801 converts the location into a feature vector and provides the feature vector to MLF 802. MLF 802 processes the feature vector using machine learning model 901 to generate a machine learning output comprising an updated list of candidate secondary cells. In this example, the new candidate cells comprise the N77 provided by RU 615 and the mmWave cell provided by RU 616.

RRC 801 interfaces with the SDAP, PDCP, RLC, MAC, and PHY to determine current loading and PCB utilization for the N77 and mmWave cell. In this example, the N77 has lower loading and PCB utilization than the mmWave cell. In response, RRC 801 selects the N77 as the secondary cell and directs the MAC in DU 619 to schedule UE 601 for service on the N77 and directs the MAC in DU 617 to stop scheduling UE 601 for service on the N25. RRC 801 generates a request to trigger an A6 measurement event to switch UE 601 from the N25 to the N77. RRC 801 transfers the A6 measurement event request to the RRC in UE 601 over the PDCPs, RLC, MACs, and PHYs. The RRC in UE 601 controls the PHY to trigger the A6 measurement event and switch from the N25 secondary cell to the N77 secondary cell. After secondary cell handover is complete, the SDAP exchanges additional user data for the PDU session with the SDAP in CU 620 over the PDCPs, RLCs, MACs, and PHYs using the primary N71 cell and the secondary N77 cell. The SDAP in CU 620 exchanges the additional data with UPF 633. UPF 633 exchanges the additional data with the AS in data network 640.

The wireless data network circuitry described above comprises computer hardware and software that form special-purpose network circuitry to select secondary cells for carrier aggregation. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to select secondary cells for carrier aggregation.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
wirelessly directing, over a primary cell, a user device to measure signal qualities for secondary cells available for use in carrier aggregation;
comparing the signal qualities for the secondary cells to a signal quality threshold;
determining candidate secondary cells based on the secondary cells that exceeded the signal quality threshold;
ranking the candidate secondary cells based on their corresponding signal qualities and one or more of loading, resource block percent utilizations, and traffic pattern suitability for the candidate secondary cells; and
wirelessly directing, over the primary cell, the wireless user device to utilize a highest ranked candidate secondary cell for use in the carrier aggregation.

2. The method of claim 1 wherein wirelessly directing the wireless user device to measure the signal qualities for the secondary cells comprises directing the wireless user device to report Received Signal Received Quality (RSRQ), Received Signal Received Power (RSRP), Physical Cell Identifier (PCI), and cell Identifier (ID) of the secondary cells.

3. The method of claim 1 wherein:
comparing the signal qualities to the signal quality threshold comprises comparing at least one of Received Signal Received Quality (RSRQ) and Received Signal Received Power (RSRP) for the secondary cells to an RSRP and/or RSRQ threshold; and
determining the candidate secondary cells based on the secondary cells that exceeded the signal quality threshold comprises determining which of the secondary cells comprise RSRP and/or RSRQ that exceeded the RSRP and/or RSRQ threshold.

4. The method of claim 1 wherein:
the signal qualities comprise Received Signal Received Quality (RSRQ) and Received Signal Received Power (RSRP); and further comprising:
determining the loading for each of candidate secondary cells and assigning loading factors to the candidate secondary cells based on their loads;
assigning signal quality factors to the candidate secondary cells based on their RSRP and RSRQ;
determining the resource block percent utilizations for the candidate secondary cells and assigning utilization factors to the candidate secondary cells based on their resource block percent utilizations and their traffic pattern suitability;
for each of the candidate secondary cells, multiplying their loading factor, their signal quality factor, and their utilization factor to determine a selection factor for the candidate secondary cells; and wherein:
wirelessly directing the wireless user device to utilize the highest ranked candidate secondary cell comprises wirelessly directing the wireless user device to utilize the candidate secondary cell with the greatest selection factor.

5. The method of claim 4 wherein the traffic patten suitability associates Frequency Division Duplexing (FDD) candidate secondary cells with uplink centric data traffic patterns and Time Division Duplexing (TDD) candidate secondary cells with downlink centric traffic patterns.

6. The method of claim 1 wherein wirelessly directing the wireless user device to utilize the highest ranked candidate secondary cell comprises directing the wireless user device to utilize a currently used one of the candidate secondary cells.

7. The method of claim 1 wherein wirelessly directing the wireless user device to utilize the highest ranked candidate secondary cell comprises directing the wireless user device to detach from a currently used one of the secondary cells and utilize the highest ranked candidate secondary cell.

8. The method of claim 1 further comprising:
hosting a machine learning model to select the highest ranked candidate secondary cell for use in the carrier aggregation, the machine learning model trained based on device location, the loading, the signal qualities, the resource block percent utilizations, and the traffic pattern suitability for the candidate secondary cells;
determining the location of the wireless user device; and wherein:
ranking the candidate secondary cells comprises providing the location of the wireless user device to the machine learning model; and
wirelessly directing the wireless user device to utilize the highest ranked candidate secondary cell for use in the carrier aggregation comprises directing the wireless user device to utilize the highest ranked candidate secondary cell for use in the carrier aggregation based on an output from the machine learning model.

9. A system comprising:
access network circuitry to:
wirelessly direct, over a primary cell, a user device to measure signal quality for secondary cells available for use in carrier aggregation;
compare the signal quality for each of the secondary cells to a signal quality threshold;
determine candidate secondary cells based on the secondary cells that exceeded the signal quality threshold;
rank the candidate secondary cells based on their corresponding signal quality and one or more of loading, resource block percent utilizations, and traffic pattern suitability for the candidate secondary cells; and
wirelessly direct, over the primary cell, the wireless user device to utilize a highest ranked candidate secondary cell for use in the carrier aggregation.

10. The system of claim 9 wherein the access network circuitry is to direct the wireless user device to report Received Signal Received Quality (RSRQ), Received Signal Received Power (RSRP), Physical Cell Identifier (PCI), and cell Identifier (ID) of the secondary cells.

11. The system of claim 9 wherein the access network circuitry is to:
compare Received Signal Received Quality (RSRQ) and Received Signal Received Power (RSRP) for the secondary cells to an RSRP and RSRQ threshold; and
determine which of the secondary cells comprise RSRP and RSRQ that exceeded the RSRP and RSRQ threshold.

12. The system of claim 9 wherein the signal quality comprises Received Signal Received Quality (RSRQ) and Received Signal Received Power (RSRP); and wherein the access network circuitry is to:
determine the loading for each of candidate secondary cells and assign loading factors to the candidate secondary cells based on their loads;
assign signal quality factors to the candidate secondary cells based on their RSRP and RSRQ;
determine the resource block percent utilizations for the candidate secondary cells and assign utilization factors to the candidate secondary cells based on their resource block percent utilizations and their traffic pattern suitability;
for each of the candidate secondary cells, multiply their loading factor, their signal quality factor, and their utilization factor to determine a selection factor for the candidate secondary cells; and
wirelessly direct the wireless user device to utilize the candidate secondary cell with the greatest selection factor.

13. The system of claim 12 wherein the traffic patten suitability associates Frequency Division Duplexing (FDD) candidate secondary cells with uplink centric data traffic patterns And Time Division Duplexing (TDD) candidate secondary cells with downlink centric traffic patterns.

14. The system of claim 9 wherein the access network circuitry is to wirelessly direct the wireless user device to utilize a currently used one of the candidate secondary cells.

15. The system of claim 9 wherein the access network circuitry is to wirelessly direct the wireless user device to detach from a currently used one of the secondary cells and utilize the highest ranked candidate secondary cell.

16. The system of claim 9 wherein the access network circuitry is to:
host a machine learning model to select the highest ranked candidate secondary cell for use in the carrier aggregation, the machine learning model trained based on device location, the loading, the signal quality, the resource block percent utilizations, and the traffic pattern suitability for the candidate secondary cells;
determine the location of the wireless user device;
provide the location of the wireless user device to the machine learning model; and
wirelessly direct the wireless user device to utilize the highest ranked candidate secondary cell for use in the carrier aggregation based on an output from the machine learning model.

17. One of more non-transitory computer readable storage media having program instructions stored thereon, wherein the program instruction, when executed by a computing system, direct the computing system to perform operations, the operations comprising:
wirelessly directing, over a primary cell, a user device to measure signal quality for secondary cells available for use in carrier aggregation;
comparing the signal quality for the secondary cells to a signal quality threshold;
determining candidate secondary cells based on the secondary cells that exceeded the signal quality threshold;
ranking the candidate secondary cells based on their corresponding signal quality and one or more of loading, resource block percent utilizations, and traffic pattern suitability for the candidate secondary cells; and
wirelessly directing, over a primary cell, the wireless user device to utilize a highest ranked candidate secondary cell for use in the carrier aggregation.

18. The computer readable storage media of claim 17 wherein wirelessly directing the wireless user device to measure the signal quality for the secondary cells comprises directing the wireless user device to report Received Signal Received Quality (RSRQ), Received Signal Received Power (RSRP), Physical Cell Identifier (PCI), and cell Identifier (ID) of the secondary cells.

19. The computer readable storage media of claim 17 wherein:
comparing the signal quality to a signal quality threshold comprises comparing Received Signal Received Quality (RSRQ) and Received Signal Received Power (RSRP) for the secondary cells to an RSRP and RSRQ threshold; and
determining the candidate secondary cells based on the secondary cells that exceeded the signal quality threshold comprises determining which of the secondary cells comprise RSRP and RSRQ that exceeded the RSRP and RSRQ threshold.

20. The computer readable storage media of claim 17 wherein:
the signal quality comprises Received Signal Received Quality (RSRQ) and Received Signal Received Power (RSRP); and the operations further comprising:
determining the loading for each of candidate secondary cells and assigning loading factors to the candidate secondary cells based on their loads;
assigning signal quality factors to the candidate secondary cells based on their RSRP and RSRQ;
determining the resource block percent utilizations for the candidate secondary cells and assigning utilization factors to the candidate secondary cells based on their resource block percent utilizations and their traffic pattern suitability;
for each of the candidate secondary cells, multiplying their loading factor, their signal quality factor, and their utilization factor to determine a selection factor for the candidate secondary cells; and wherein:
wirelessly directing the wireless user device to utilize the highest ranked candidate secondary cell comprises wirelessly directing the wireless user device to utilize the candidate secondary cell with the greatest selection factor.
